(19) United States
(12) Patent Application Publication
(10) Pub. No.: US 2026/0232111 A1
(43) Pub. Date: Aug. 13, 2026

(54) TELESCOPIC RAIL WITH IMPROVED FLEXURAL STRENGTH

(71) Applicant: Accuride International GmbH, Diez (DE)

(72) Inventor: Christoph NEUHAUS, Niederelbert (DE)

(21) Appl. No.: 19/153,154

(22) PCT Filed: Feb. 16, 2024
(86) PCT No.: PCT/EP2024/054002

§ 371 Date: Aug. 1, 2025

(30) Foreign Application Priority Data
Feb. 21, 2023 (DE) 20 2023 100 817.8

(51) Int. Cl. A47B 88/493; F16C 29/02; F16C 29/04

(52) U.S. Cl. CPC A47B 88/493; F16C 29/02; F16C 29/04; A47B 2210/0029; F16C 2220/42; F16C 2220/44; F16C 2223/14; F16C 2223/16

(57) ABSTRACT

Telescopic rail with rail elements mounted for linear displacement relative to one another via rolling element bearings or plain bearings is disclosed. At least a first rail element is manufactured from a rolled steel sheet and the surface of the steel sheet has a surface layer produced by a nitriding process.

### SUBJECT MATTER OF THE INVENTION

The present invention relates to a telescopic rail having a first rail element, a second rail element which is mounted on the first rail element so as to be linearly displaceable via a rolling element bearing or a plain bearing, and optionally a third rail element which is mounted on the first or the second rail element so as to be linearly displaceable via a rolling element bearing or a plain bearing.

### BACKGROUND OF THE INVENTION

Telescopic rails within the meaning of the present invention have at least a first and a second rail element and optionally a third, possibly also a fourth rail element, which are generally of the same or similar length and are mounted for linear displacement relative to one another via rolling element bearings or plain bearings. Telescopic rails with two rail elements form a so-called partial extension, whereas telescopic rails with three or more rail elements are referred to as full extension. Rolling element or plain bearings between the rail elements are used to reduce friction and improve smooth running and load transfer. Balls in particular, but also rollers, drums, needles, cones, etc. are used as rolling elements. When the rail elements are moved against each other, the rolling elements are rolled and guided on raceways which are formed on the rail elements according to their shape. In the case of plain bearings, either sliding bodies are guided between the rail elements on appropriately shaped raceways or sliding tracks or the sliding surfaces are formed on the rail elements themselves.

In order to keep rolling elements at a certain distance from each other and to prevent the rolling elements from running apart or falling out of the telescopic rail when the rail elements are moved, they are guided in rolling element cages arranged between the rail elements. If balls are used as rolling elements, these are referred to as ball cages. Insofar as the following refers to balls as rolling elements and ball cages as rolling element cages, this also includes other types of rolling elements and rolling element cages, unless this is expressly excluded or technical reasons speak against rolling elements other than balls.

Telescopic slides are used for the guided linear movement of an element in relation to another element. In most applications, they are used for the holding and linear displacement, in particular the pulling out and pushing in, of a pull-out element, such as a drawer, a shelf or another component, on a corpus, such as a piece of furniture, a technical cabinet, a computer rack or a piece of kitchen furniture, for example an oven or refrigerator. Telescopic slides are also used in automotive engineering to hold and move seats, doors, consoles, etc. on, in and in relation to the vehicle. In these applications, the telescopic rails are fixed to the corpus with one of the rail elements, the so-called stationary rail element, and the pull-out element is attached to a rail element that can be moved relative to the stationary rail element. In the case of telescopic slides with more than two rail elements mounted so that they can slide relative to each other, as in the case of full-extension slides, the pull-out element is attached to the rail element furthest away from the stationary rail element.

The rail elements of telescopic rails can have a wide variety of cross-sectional profiles. The most common is the C-profile with a web, which forms the back of the rail, and with flanges formed at opposite ends of the web and extending at an angle from the web, on which the raceways of the rail element are formed. In most applications, the rail elements are mounted with the web or back of the rail in a vertical orientation, as the profile has the highest bending strength under load in this orientation and ensures the best load transfer via the rolling or sliding elements on the raceways.

Rail elements for telescopic slides are manufactured from different materials, in different sizes and using different processes, depending on the application and the requirements in terms of extension length, load to be supported or load capacity and available installation space.

Rail elements for low to medium loads, such as in furniture construction or for ovens, are regularly manufactured from rolled sheet steel, which is delivered as so-called coil material of a certain material thickness, cut and/or punched and formed into the desired shape of the rail element profile by bending. In this way, rail elements can be manufactured in large quantities and relatively inexpensively on corresponding production lines. Disadvantages arise with telescopic rails composed of such rail elements if they are to be used for high loads that go along with high, downward vertical forces. Especially in the extended state, these high forces cause a strong bending load, i.e. a high bending moment, which causes the rail elements to bend and the pull-out element does not remain in the intended horizontal plane in which the telescopic rail is mounted, but tilts or hangs down when the telescopic rail is extended. In addition, severe bending of the rail elements can cause the running properties of the rolling element or plain bearings to deteriorate considerably, to the extent of blocking the displaceability, especially when long rolling element cages are used, which in turn are required for better load transfer under high loads.

In order to counteract such strong bending under high loads and to achieve a higher bending strength, such rail elements bent from rolled sheet metal currently have to be made more stable by using thicker steel sheets compared to telescopic rails for low to medium loads and by making the rail elements higher and wider. However, this in turn entails considerably higher costs due to the larger amount of material required in the form of the steel sheets. In addition, the required larger dimensions of the rail elements mean that the entire telescopic rail is considerably higher and wider and therefore requires a larger installation space, which is undesirable or not available at all in many applications.

For this reason, special heavy-duty rails are used, especially for high load requirements, in which the rail elements are manufactured in a different way than the rail elements bent from rolled sheet metal. The rail elements of such heavy-duty rails are usually manufactured with special cross-sectional geometries of the profiles, which ensure a particularly high bending strength. For this purpose, for example, elements that reinforce the bending strength are provided in certain regions of the profile, such as wall thicknesses that are thicker in some sections than in others, protrusions, etc. Such profiles provide high stability of the rail element, including high bending strength. However, they cannot be manufactured from rolled sheet metal in a simple bending forming process, but are usually drawn from steel using a female die or a drawing die, extruded or even milled from solid material. These manufacturing processes are complex and expensive, also in terms of the amount of material required. In addition, such rail elements often have a high weight. If stainless steel is used in the manufacture of such rail elements to improve corrosion resistance, the costs increase further, as stainless steel is more expensive and the processing is more difficult and complex than with normal steel and more material must also be used, as stainless steel has a lower load-bearing capacity than normal steel.

DE 103 40 482 discloses a telescopic rail designed as a slide rail, which has a coating of a hard material, in particular an enamel coating, on the sliding surfaces. The telescopic slide is intended for use in the food industry and in baking ovens and pyrolytic ovens and does not require lubricants because the enamel coating has good sliding properties and is resistant to high temperatures.

U.S. Pat. No. 11,149,790 discloses a linear guide with a long rail element and a carriage that can move on it. According to the invention, the carriage is to be manufactured from a single metal plate. The rail element and the carriage can be surface hardened using known methods in order to give the running surfaces for the ball bearing greater wear resistance.

### OBJECT OF THE INVENTION

The object of the present invention was to provide a telescopic rail which eliminates the disadvantages of the prior art and which can be manufactured in a cost-efficient and material-saving manner with higher stability, in particular higher bending strength, compared to the prior art.

### DESCRIPTION OF THE INVENTION

According to the invention, this object is solved by a telescopic rail having a first rail element, a second rail element which is mounted on the first rail element so as to be linearly displaceable via a rolling element bearing or a plain bearing, and optionally a third rail element which is mounted on the first or the second rail element so as to be linearly displaceable via a rolling element bearing or a plain bearing, and
wherein at least the first rail element is manufactured from a rolled steel sheet and the surface of the steel sheet has a surface layer produced by means of a nitriding process with a nitriding hardness depth (Nht) in the range of 0.05 mm to 0.6 mm.

The telescopic rail according to the invention is preferably designed either as a partial extension with a first rail element and a second rail element or as a full extension with a first rail element, a second rail element and a third rail element. The first rail element according to the invention can be an outer rail element, an inner rail element or, in the case of a full extension, also a middle rail element. In one embodiment of the invention, all rail elements of the telescopic rail according to the invention are manufactured from rolled sheet steel.

Preferably, the entire surface of the first rail element made of rolled sheet steel is provided with a surface layer produced by means of a nitriding process. In one embodiment of the telescopic rail according to the invention, the entire surfaces of all rail elements of the telescopic rail are provided with a surface layer produced by means of a nitriding process.

The telescopic rail according to the invention has the advantages of known telescopic rails in which the rail elements are manufactured from rolled sheet steel by bending forming, namely a much more cost-effective production in large quantities compared to known heavy-duty rails manufactured from drawn, extruded or milled solid steel. At the same time, the rail elements with the surface layer produced according to the invention by means of a nitriding process surprisingly have a significantly higher stability, in particular higher bending strength, so that the telescopic rails according to the invention meet higher load requirements than telescopic rails with rail elements made of rolled sheet steel without the surface layer according to the invention with the same material thickness, the same geometry and the same dimensions. The advantages of the increased bending stability are particularly evident in the extended state of the telescopic rail, in which the leverage forces of the loaded movable rail elements on the stationary rail elements are particularly high.

The surface treatment of steel components by nitriding is a well-known process that is generally used to improve the corrosion resistance of the material and to increase the surface hardness in order to protect the surface from scratches or other local damage and from severe abrasion. Surface nitriding has also already been used for telescopic rails, for example in EP 2 347 141, in order to better protect the surfaces of the raceways against abrasion, damage and roughening by the rolling elements in a telescopic rail made of drawn steel with ball or roller bearings, which is designed for high loads in the sense of a heavy-duty rail and also has corresponding geometries of the profiles of the rail elements. Aspects such as the bending stability of the rail elements are not addressed in this context in EP 2 347 141 and obviously do not play a role there, as the rail elements are already manufactured from drawn steel in the manner of a heavy-duty rail with a correspondingly stabilized profile geometry.

Against this background, the significant increase in bending strength achieved in the rail elements according to the invention with the surface layer produced by a nitriding process was surprising and not to be expected. Compared to known telescopic rails made of rolled sheet steel, the telescopic rails according to the invention can be used for higher loads with the same design without the telescopic rails bending more than the known telescopic rails, especially when extended. Conversely, telescopic rails according to the invention can be manufactured with the same load requirements using less material in terms of the material thickness of the sheet steel used and/or in smaller dimensions in terms of height and width, which means that manufacturing costs can be saved and the telescopic rails place lower demands on the available installation space while having the same load capacity.

In a preferred embodiment of the invention, the first rail element has a C-profile in cross-section.

In a further embodiment of the invention, the second rail element and/or the optional third rail element are also manufactured from a rolled steel sheet and have a C-profile in cross-section and the surface of the steel sheet of the second rail element and/or the surface of the steel sheet of the optional third rail element has a surface layer manufactured by means of a nitriding process, preferably over the entire surface.

The C-profile of the rail elements made of rolled sheet steel has advantages over other profiles in terms of economic manufacturability with high throughput on conventional production lines and in terms of material costs. By providing the surface layer produced by a nitriding process according to the invention, the bending strength of the C-profile and thus the load-bearing capacity of the telescopic rails made from it is significantly increased.

A C-profile in the sense of the present invention refers to a cross-sectional profile with a web, which forms the back of the rail, and with flanges (upper flange and lower flange) formed at opposite ends of the web and extending at an angle or bent from the web, on which the raceways of the rail element are formed. Optionally, lips (upper lip and lower lip) can be arranged at the free ends of the flanges, which extend at an angle to the flange in the direction of the opposite flange. The increased flexural strength achieved by the invention is particularly advantageous if the telescopic rail is mounted with the web or rail back of the rail elements in a vertical orientation, as the profile has the highest flexural strength under load in this orientation and ensures the best load transfer via the rolling or sliding elements on the raceways. However, the telescopic rail according to the invention also has a higher bending strength perpendicular to the web or rail back of the rail elements compared to known telescopic rails of the same design made of rolled sheet steel.

Conveniently, the steel of the rolled steel sheet from which the rail elements of the telescopic rail according to the invention are manufactured is construction steel, stainless steel or micro-alloyed steel. The choice of material depends, among other things, on economic aspects and the requirements of the telescopic rail. Construction steel has the advantage that it is cheaper than stainless steel and is also easier to machine and form into the rail elements. Stainless steel or micro-alloyed steel can have advantages in terms of corrosion resistance in certain applications. The respective rail elements of a telescopic rail can also be manufactured from different steels.

The profile of the first rail element and preferably also the profile of the second rail element and/or the optional third rail element are preferably manufactured from the rolled sheet steel by bending forming.

When reference is made herein to telescopic rails within the meaning of the present invention, this excludes so-called linear guides, which, in contrast to telescopic rails, are characterized in that a single long rail element is fixed or fixable in a stationary position on a corpus or a wall via several fixing points and a very short rail element, which is also referred to as a slide or carriage, is mounted on the long rail element so as to be displaceable, but not beyond the ends of the long rail element. The problem of bending loads does not occur with linear guides as it does with telescopic rails, as with linear guides there is no extension of movable rail elements beyond the ends of the stationary fixed rail element and therefore the lever forces acting on telescopic rails do not occur. Where surface treatment by nitriding was known for linear guides, this only concerned the surfaces of the rolling element tracks in order to protect them against wear caused by the rolling elements rolling off.

In one embodiment of the telescopic rail according to the invention, the sheet steel of the first rail element and preferably also the profile of the second rail element and/or the optional third rail element has a material thickness in the region of 1.0 mm to 4.0 mm. Preferably, the steel sheet has a material thickness in the region of 1.2 mm to 3.0 mm or from 1.5 mm to 2.5 mm or from 1.5 mm to 2.2 mm. It has been shown that the telescopic rail according to the invention has a high bending strength even with a relatively low material thickness of the rail elements due to the surface layer of the rail elements produced by means of a nitriding process. It is understood that the steel sheets of different rail elements of the same telescopic rail do not necessarily have to have the same material thickness. The outer rail, the inner rail and any middle rail may be manufactured from sheet steel of different material thicknesses.

In a further embodiment of the telescopic rail according to the invention, the sheet steel of the first rail element and preferably also the sheet steel of the second rail element and/or the optional third rail element have the same material thickness throughout the profile with a maximum tolerance deviation of no more than ±10%, preferably no more than ±5%, particularly preferably no more than ±3%, relative to the mean material thickness of the entire sheet steel of the respective rail element. Among other things, this has advantages during manufacture, as the rail elements can be manufactured in this way from commercially available coil material, which is usually supplied with the same material thickness over the entire material. Due to the increased bending strength achieved by the surface layer of the rail elements produced by means of a nitriding process, it is not necessary to change the material thickness within the profile in certain regions, as is the case with known heavy-duty rails, in order to obtain sufficient stability, in particular bending strength, of the rail elements.

As mentioned earlier, the surface treatment of steel components by nitriding is a well-known process, whereby there are different process variants such as gas nitriding, plasma nitriding, salt bath nitriding, vacuum nitriding etc. In the nitriding process, the surface of the workpiece is chemically altered by incorporating nitrogen by diffusion. If carbon is added to the nitrogen, this is referred to as nitrocarburizing. A hard, surface compound layer is formed on the surface of the workpiece by the diffusion of nitrogen, which comprises iron nitrides and, if necessary, so-called special nitrides of nitride-forming alloy components of the material, such as chromium, molybdenum, vanadium or aluminum. A diffusion zone forms under the compound layer, in which the nitrogen is incorporated into the metal matrix to a certain depth. The thickness or depth of the compound layer and the diffusion zone starting from the workpiece surface depends on the treatment parameters, in particular the process itself, the treatment temperature and the treatment duration. The so-called “nitriding hardness depth” (Nht) or nitriding hardness depth (NHD) is defined by the limit hardness at which the hardness in the diffusion zone is 50 HV above the core hardness of the workpiece.

Nitriding processes are generally used to protect the material from local damage and abrasion by increasing the external surface hardness, to improve the corrosion resistance of the material and, if necessary, to improve the coefficient of friction of the surface. Subsequent oxidation of the compound layer (directly in the nitriding process or as a separate process) can further improve the corrosion resistance and the coefficient of friction. In this process, iron nitride on the surface of the compound layer of the workpiece is converted into iron oxide and a protective oxide layer is formed. The original white or light color of the surface due to the nitrides changes to anthracite.

According to the invention, the surface layer of the first rail element and preferably also the surface layer of the second rail element and/or of the optional third rail element is expediently manufactured by means of a gas nitriding process, a plasma nitriding process, a vacuum nitriding process, a gas or plasma nitrocarburizing process or a salt bath nitrocarburizing process. However, the gas nitriding process is particularly preferred. It is comparatively inexpensive and allows good control of the nitriding parameters. In one embodiment of the invention, the surface layer produced by the nitriding process according to the invention is subjected to subsequent oxidation, so that the surface layer of the first rail element and preferably also the surface layer of the second rail element and/or the optional third rail element contains iron oxide formed by the post-oxidation process downstream of the nitriding process.

In the telescopic slide rail according to the invention, the nitriding hardness depth (Nht) of the surface layer of the first rail element produced by the nitriding process is in the range of 0.05 mm to 0.6 mm. In one embodiment of the telescopic rail according to the invention, the nitriding hardness depth (Nht) of the surface layer of the first rail element produced by means of the nitriding process and also of the surface layer of the second rail element and the optional third rail element is in the region of 0.05 mm to 0.6 mm, preferably in the region of 0.075 mm to 0.5 mm or in the region of 0.10 mm to 0.3 mm or in the region of 0.15 mm to 0.2 mm, or alternatively, based on the material thickness of the steel sheet, in the region of 1% to 40%, preferably in the region of 3% to 35% or in the region of 5% to 20% or in the region of 8% to 15% of the material thickness of the steel sheet.

If the nitriding hardness depth (Nht) is too low, the advantage of increased flexural strength of the rail elements according to the invention does not come into play, or only to a limited extent. If the nitriding hardness depth (Nht) is too high, this can impair the basic elasticity of the rail elements due to a material change penetrating too deeply into the material, such as embrittlement or phase transformation, as a result of which there is a risk of cracks or even breakage of the rail elements under high load and/or after prolonged use.

When it is stated herein that according to the invention the surface of the steel sheet of a rail element has a surface layer produced by means of a nitriding process, it should not be excluded that one or more layers or coatings are applied or manufactured over this surface layer, such as essentially decorative, dirt-repellent and/or corrosion-protective layers or coatings. In one embodiment according to the invention, a galvanically deposited zinc layer is arranged on at least one rail element, preferably on all rail elements, over the surface layer produced by means of a nitriding process.

### EXAMPLE

In a load test, the bending strength of a commercially available partial extension telescopic rail was compared with the bending strength of an identical telescopic rail according to the invention, in which the surfaces of the steel sheets of the rail elements were provided with a surface layer produced by means of a nitriding process according to the invention. The telescopic rails consisted of two rail elements, each 360 mm long, with a C-profile made of rolled construction steel sheet and with ball bearings for sliding against each other. The C-profile of the outer rail element had a height of 35 mm and a sheet steel material thickness of 1.52 mm. The inner rail element had a sheet steel material thickness of 2.0 mm. The maximum extension length of the telescopic rail was 200 mm. The nitriding depth of the telescopic rail according to the invention, in which the rail elements were both provided with a surface layer produced by means of a nitriding process, was approximately 0.15 mm.

In the test arrangement, two commercially available telescopic rails as well as two telescopic rails according to the invention were fixed in pairs opposite each other with the respective outer rail elements as stationary rail elements in horizontal alignment of the travel path, i.e. with vertical alignment of the rail back, and with inner rail elements facing each other on opposite body walls. The inner rail elements were connected via a U-shaped lever, to the U-legs of which the inner rail elements were attached. The sliding inner rail elements were fully extended (200 mm extension) and loaded via the lever at a load point at a distance of 410 mm from the end of the outer rail or 210 mm from the free end of the extended inner rail with a vertically downward force of 800 Newtons. The deflection, i.e. the vertically downward bending of the rails, was measured at the load point. The deflection of the commercially available telescopic rails used for comparison purposes was 18.9 mm in this load test, while the deflection of the telescopic rails according to the invention was only 6.8 mm. By providing the rail elements with the surface layer according to the invention, it was thus possible to reduce the deflection of the telescopic rails in this load test by around 64% compared to the commercially available telescopic rails.

1. A telescopic rail comprising:
a first rail element,
a second rail element which is mounted on the first rail element so as to be linearly displaceable via a rolling element bearing or a plain bearing, and
optionally a third rail element which is mounted on the first or the second rail element so as to be linearly displaceable via a rolling element bearing or a plain bearing,
wherein at least the first rail element is manufactured from a rolled steel sheet and the surface of the steel sheet has a surface layer produced by a nitriding process with a nitriding hardness depth (Nht) in the range of 0.05 mm to 0.6 mm.

2. The telescopic rail according to claim 1, wherein the first rail element has a C-profile in cross-section.

3. The telescopic rail according to claim 1, wherein the second rail element and/or the optional third rail element are also manufactured from a rolled steel sheet and have a C-profile in cross-section, and
wherein the surface of the steel sheet of the second rail element and/or the surface of the steel sheet of the optional third rail element has a surface layer manufactured by a nitriding process.

4. The telescopic rail according to claim 1, wherein the entire surface of the first rail element made of rolled steel sheet is provided with a surface layer produced by a nitriding process.

5. The telescopic rail according to claim 1, wherein the steel of the steel sheet is construction steel, stainless steel or micro-alloyed steel.

6. The telescopic rail according to claim 1, wherein the profile of the first rail element is manufactured from rolled steel sheet by bending forming.

7. The telescopic rail according to claim 1, wherein the steel sheet of the first rail element has a material thickness in the region from 1.0 mm to 4.0 mm.

8. The telescopic rail according to claim 1, wherein the steel sheet of the first rail element has the same material thickness throughout the profile with a maximum tolerance deviation of not more than ±10% relative to the mean material thickness of the entire steel sheet of the first rail element.

9. The telescopic rail according to claim 1, wherein the surface layer of the first rail element is manufactured by a gas nitriding process, a plasma nitriding process, a vacuum nitriding process, a gas or plasma nitrocarburizing process or a salt bath nitrocarburizing process.

10. The telescopic rail according to claim 1, wherein the surface layer of the first rail element contains iron nitride formed by a nitriding process.

11. The telescopic rail according to claim 1, wherein the surface layer of the first rail element contains iron oxide formed by a post-oxidation process downstream of the nitriding process.

12. The telescopic rail according to claim 1, wherein the surface layer of the first rail element produced by a nitriding process has a nitriding hardness depth (Nht) in the region of 0.075 mm to 0.5 mm.

13. The telescopic rail according to claim 1, wherein the surface layer of the first rail element produced by a nitriding process has a nitriding hardness depth (Nht) in the region of 1% to 40% of the material thickness of the steel sheet.

14. The telescopic rail according to claim 1, wherein the telescopic rail is designed as a partial extension with the first rail element and the second rail element or as a full extension with the first rail element, the second rail element, and the third rail element.

15. The telescopic rail according to claim 4, wherein the entire surfaces of all rail elements of the telescopic rail are provided with a surface layer produced by a nitriding process.

16. The telescopic rail according to claim 6, wherein the profile of the second rail element and/or the optional third rail element are manufactured from rolled steel sheet by bending forming.

17. The telescopic rail according to claim 3, wherein the steel sheet of all rail elements of the telescopic rail has the same material thickness throughout the profile with a maximum tolerance deviation of not more than ±10% relative to the mean material thickness of the entire steel sheet of the respective rail element.

18. The telescopic rail according to claim 3, wherein the surface layer of all rail elements of the telescopic rail contains iron nitride formed by a nitriding process.

19. The telescopic rail according to claim 3, wherein the surface layer of all rail elements of the telescopic rail contains iron oxide formed by a post-oxidation process downstream of the nitriding process.

20. The telescopic rail according to claim 3, wherein the surface layer of all rail elements of the telescopic rail produced by a nitriding process has a nitriding hardness depth (Nht) in the region of 1% to 40% of the material thickness of the steel sheet.
